(19) United States
(12) Patent Application Publication
(10) Pub. No.: US 2011/0197410 A1
(43) Pub. Date: Aug. 18, 2011

(54) FRANGIBLE COLLAR REMOVAL TOOL

(76) Inventors: John Manley Estep, Troy, PA (US); Mark Dalen West, West Burlington, PA (US); Curtis Brian Route, Troy, PA (US)

(21) Appl. No.: 13/027,961

(22) Filed: Feb. 15, 2011

Related U.S. Application Data
(60) Provisional application No. 61/304,592, filed on Feb. 15, 2010.

(51) Int. Cl. B23P 19/04; B25F 3/00

(52) U.S. Cl. 29/240; 279/145

(57) ABSTRACT

A collar removal tool can be used on the same type power tool that is used to install frangible collar fasteners. The collar removal tool can be an accessory attachment that couples to the power tool. The collar removal tool can be designed to grip the fastener collar via a collet mechanism that is self-tightening using the power tool. The collar may be removed with the tool running in the reverse rotation, which is the same direction of rotation required to tighten the collet on the collar by raising the collet up into a collet holder. After the collar is loosened and removed from the bolt, the tool can be run in the forward direction and the collar mechanism can automatically loosen the collet on the collar. The collar can then be free to fall from the collar removal device.

### CROSS-REFERENCE TO RELATED APPLICATIONS

This application claims the benefit of priority to U.S. Provisional patent application No. 61/304,592, filed Feb. 15, 2010, the contents of which are herein incorporated by reference.

### BACKGROUND OF THE INVENTION

The present invention generally relates to fasteners used in the aerospace industry and, more specifically, to a frangible collar removal tool.

In the aerospace industry, a large number of fasteners that are used in the assembly of aircraft structures are a design style referred to as “frangible collar” fasteners. These fasteners are basically a collar with a break-off nut that is designed to break off the nut portion at a designed torque and leave the collar threaded onto the bolted assembly to provide the clamp load. This is a quick failsafe way to assemble a collar and bolt without having to control and certify the torque applied to the fasteners. The problem comes with any repair work that is required after the initial assembly. To disassemble the “collar” one must manually grab the collar with pliers and loosen the collar. Most of the collars are in difficult to access areas and the removal process is time consuming and hard to accomplish.

As can be seen, there is a need for a device to quickly and easily remove frangible collars.

### SUMMARY OF THE INVENTION

In one aspect of the present invention, a tool for removing a fastener from a bolt comprises a collet holder; a collet disposed inside a first end of the collet holder; a flared end of the collet extending from the first end of the collet holder; collet threads on at least a portion of an inside surface of the collet; a drive shaft disposed inside a second, opposite end of the collet holder; and drive shaft threads adapted to mate with the collet threads, wherein rotation of the drive shaft causes the collet to be further inserted into the collet holder, causing the flared end of the collet to be compressed together by the collet holder.

In another aspect of the present invention, a device for removing frangible collars from a bolt comprises a collet holder; a collet disposed inside a first end of the collet holder; a flared end of the collet extending from the first end of the collet holder; collet threads on at least a portion of an inside surface of the collet; a drive shaft disposed inside a second, opposite end of the collet holder; drive shaft threads adapted to mate with the collet threads; a set screw passing through the collet holder and into an axial slot cut into at least a portion of the collet, the set screw and axial slot permitting relative axial movement between the collet and the collet holder and preventing relative radial movement between the collet and the collet holder; a mounting bracket having a mounting bracket hole formed therein, the mounting bracket hole allowing a portion of the drive shaft to pass therethrough; and a support arm having a support arm hole formed therein, the support arm hole allowing a portion of the collet to pass therethrough, wherein rotation of the drive shaft causes the collet to be further inserted into the collet holder, causing the flared end of the collet to be compressed together by the collet holder.

These and other features, aspects and advantages of the present invention will become better understood with reference to the following drawings, description and claims.

### BRIEF DESCRIPTION OF THE DRAWINGS

FIG. 1 is a top view of a collar removal tool according to an exemplary embodiment of the invention;

FIG. 2 is a cross-sectional view of the collar removal tool taken along line 2-2 of FIG. 1;

FIG. 3 is a front view of the collar removal tool of FIG. 1;

FIG. 4 is a cross-sectional view of the collar removal tool of FIG. 3 taken along line 4-4 of FIG. 3;

FIG. 5 is a cross-sectional view of the collar removal tool of FIG. 3 taken along line 5-5 of FIG. 4;

FIG. 6 is a side view of the collar removal tool of FIG. 1 as used on a power tool with a crowfoot attachment; and

FIG. 7 is an exploded assembly view of the collar removal tool of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention generally provides a frangible collar removal tool (also referred to as collar removal tool) that can be used on the same type power tool that is used to install frangible collar fasteners. The collar removal tool can be an accessory attachment that couples to the power tool. The collar removal tool can be designed to grip the fastener collar via a collet mechanism that is self-tightening using the power tool. Within the center of a hex drive shaft is a through hole to allow for the use of a tool to prevent the bolt from rotating. The fastener may be removed with the tool running in the reverse rotation, which is the same direction of rotation required to tighten the collet on the collar by raising the collet up into a collet holder. After the collar is loosened and removed from the bolt, the tool can be run in the forward direction and the collar mechanism can automatically loosen the collet on the collar. The collar can then be free to fall from the collar removal device.

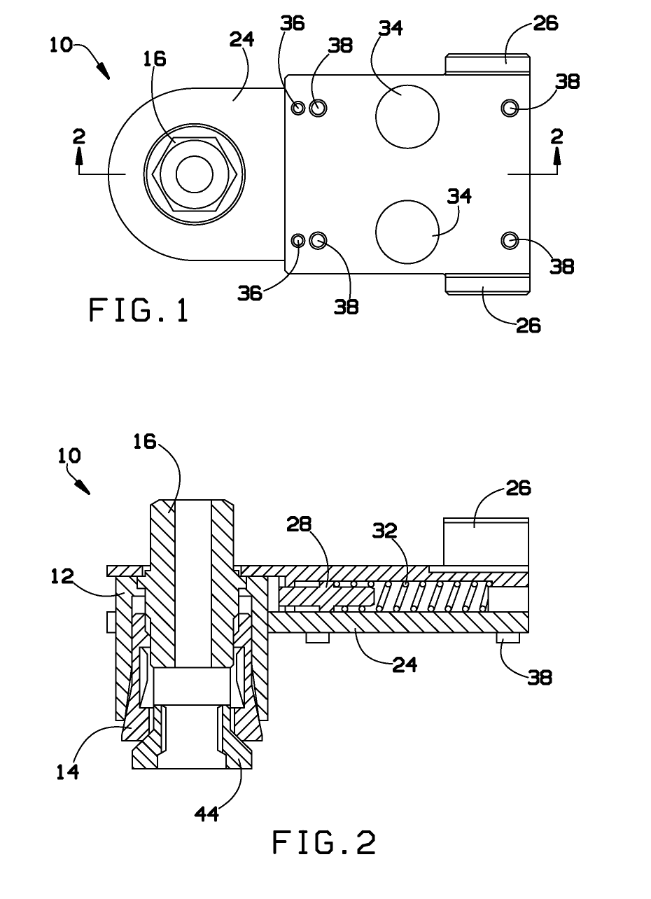

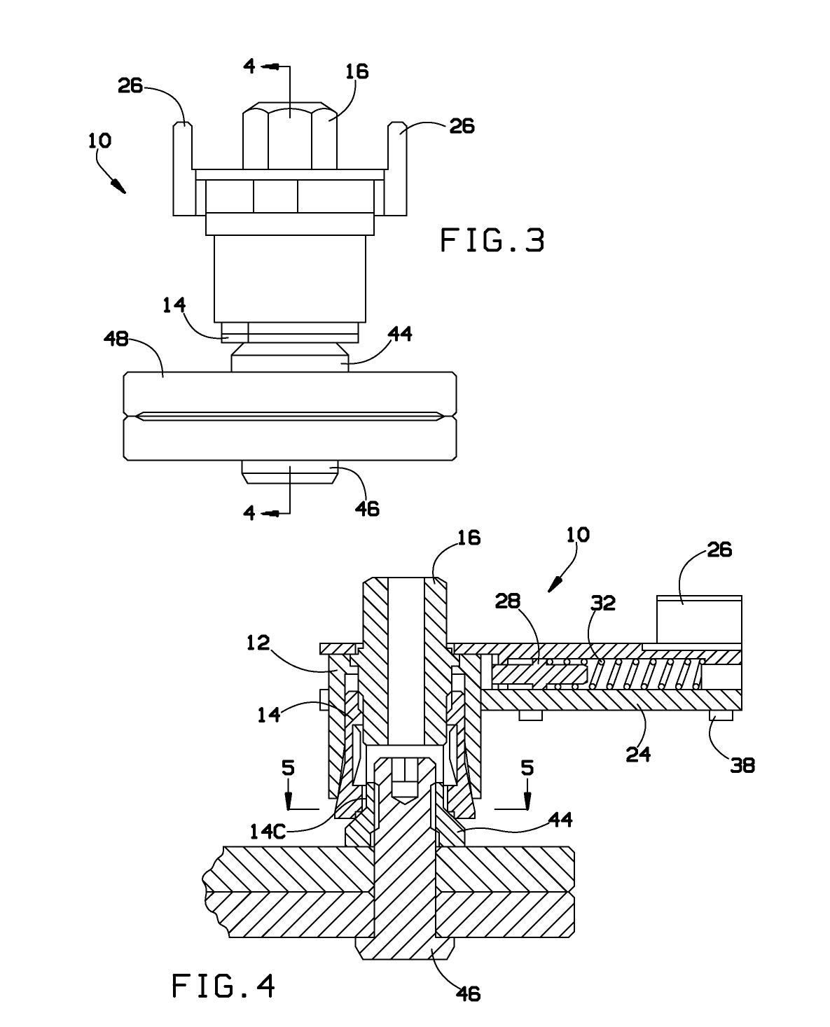

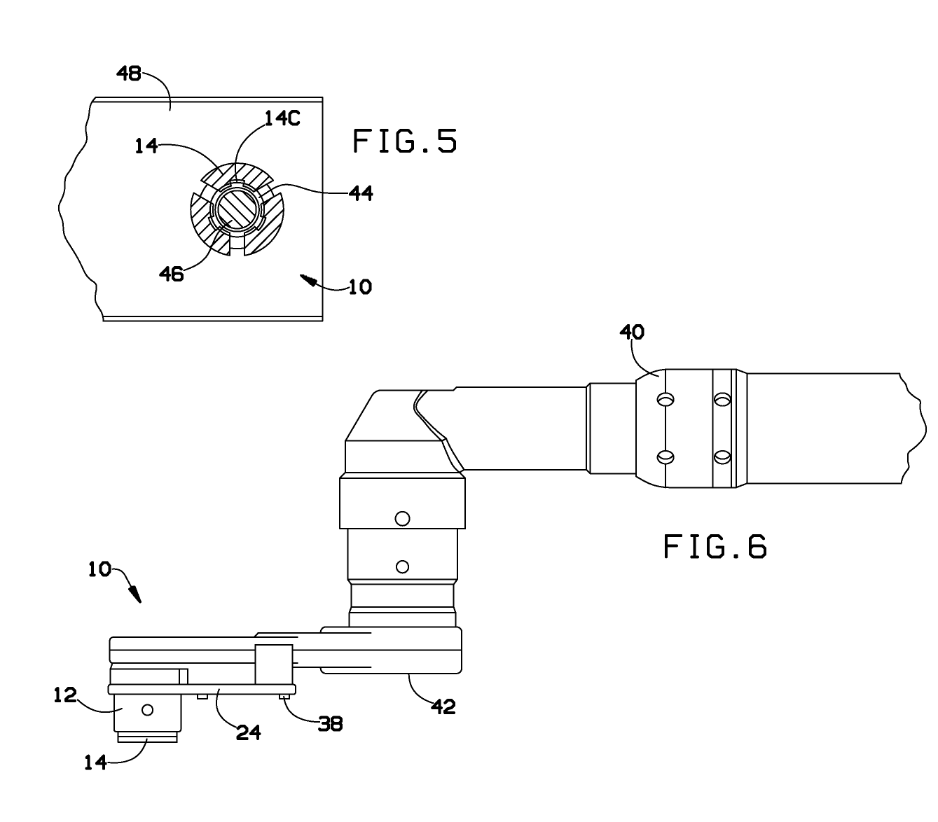

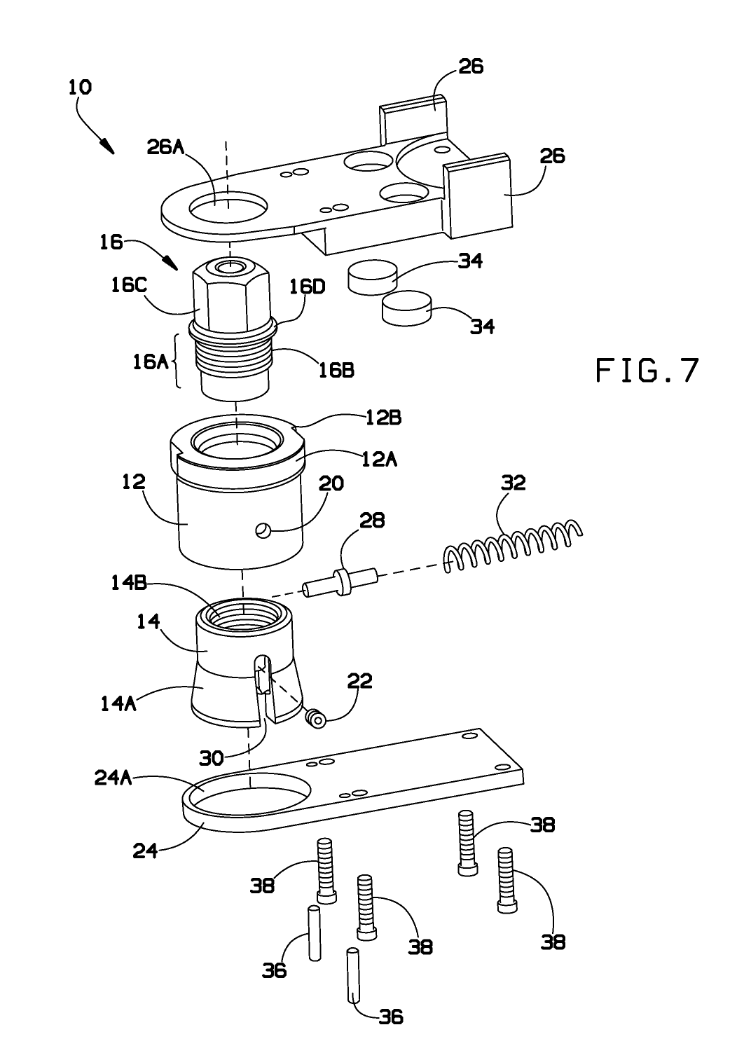

Referring to FIGS. 1 through 7, a collar removal tool 10 may include a collet holder 12 adapted to receive a collet 14 partially inside the collet holder 12. The collet 14 may have a flared end 14a that extends beyond the end of the collet holder 12 when the collet 14 is installed in the collet holder 12. A set screw 22 may pass through a hole 20 in the collet holder 12 and pass into an axial slot 30 cut in the collet 14. The set screw 22 may prevent rotation of the collet 14 relative to the collet holder 12. The set screw 22 may permit the collet 14 to move into and out of the collet holder 12 by virtue of the slot 30. The slot 30 may be cut only through a portion of the collet 14 (starting at the flared end 14a), thereby providing a stop to prevent the collet 14 from falling out of the collet holder 12 when in use.

A drive shaft 16 may have a portion 16a that extends into the collet holder 12 and the collet 14. A part of this portion 16a of the drive shaft 16 may have threads 16b disposed thereabout. The collet 14 may have mating threads 14b on an inside surface thereof. In some embodiments, the threads 16a, 14b may be left-hand threads, where counterclockwise rotation of the drive shaft 16 causes the collet 14 to be raised into the collet holder 12. The drive shaft 16 may have a protruding portion 16c extending out of the collet holder 12. The protruding portion 16c may have a shape adapted to be gripped and rotated by a power tool 40. In some embodiments, the protruding portion 16c may be hexagonal shaped.

The drive shaft 16 and collet holder 12 may be retained between a mounting bracket 26 and a support arm 24. A hole 26a in the mounting bracket 26 may allow the protruding portion 16c of the drive shaft 16 to pass therethrough. A shoulder 16d on the drive shaft 16 may prevent the drive shaft 16 from being removed through the hole 26a. A hole 24a in the support arm 24 may allow the collet 14 to pass therethrough, into the collet holder 12. A plurality of bolts 38 and pins 36 may be used to secure the mounting bracket 26 to the support arm 24.

A pin 28 may be resiliently disposed against a top portion 12a of the collet holder 12 with a spring 32. The pin 28 may permit counter-clockwise (reverse) rotation of the collet holder 12. However, the pin 28 may catch on an edge 12b of the top portion 12a of the collet holder 12 to prevent rotation of the collet holder 12 in the clockwise (forward) direction. This may allow the power tool 40 to turn the drive shaft 16 in a forward direction, causing the collet 14 to be extended out of the collet holder 12, causing the flared end 14a of the collet 14 to open and release a retained collar 44.

The mounting bracket 26 may include one or more magnets 34 to help retain the collar removal tool 10 to a crowfoot attachment 42 of the power tool 40. This design may allow for easy removal of one tool 10 and placement of another tool 10 having, for example, a collet 14 for a different size collar 44. This design may result in a modular tool kit including the power tool 40 and multiple removal tools 10 for each of the various sized collars 44. Optionally, a user may change collet size by removing the set screw 22, pulling out the collet 14, inserting a different collet and resetting the set screw 22. This size change, however, may not be recommended in some applications since small parts, such as the set screw 22, may become lost.

The removal tool 10 may be used to remove the collar 44 from a bolt 46 which may be attached to a component assembly 48. To use the removal tool 10, a user may attach the power tool 40 to the removal tool 10, where the power tool 40 may provide rotational torque to the drive shaft 16. By turning the drive shaft 16 in the reverse direction, the collet 14, which is disposed about the collar 44, may be raised into the collet holder 12. This action may push the flared end 14a of the collet 14 together, causing the collet 14 to grip the collar 44. In some embodiments, the end of the collet 14 may have ridges 14c to help the collet 14 grip on the collar 44. Once the collet 14 has gripped the collar, further reverse rotation of the drive shaft 16 causes the collet 14 and collet holder 12 to rotate, unthreading the collar 44 from the bolt 46. Once the collar 44 is removed, the power tool 40 may be set to change rotation direction. Forward rotation of the drive shaft 16 may cause the collet 14 to be extended from the collet holder 12, causing the flared end 14a to open, thereby releasing the collar 44.

In an alternative embodiment, the device can be used on a standard power tool with a reaction adapter to limit reaction movement due to reverse torque.

It should be understood, of course, that the foregoing relates to exemplary embodiments of the invention and that modifications may be made without departing from the spirit and scope of the invention as set forth in the following claims.

What is claimed is:

1. A tool for removing a collar from a bolt, the tool comprising:
a collet holder;
a collet disposed inside a first end of the collet holder;
a flared end of the collet extending from the first end of the collet holder;
collet threads on at least a portion of an inside surface of the collet;
a drive shaft disposed inside a second, opposite end of the collet holder; and
drive shaft threads adapted to mate with the collet threads, wherein
rotation of the drive shaft causes the collet to be further inserted into the collet holder, causing the flared end of the collet to be compressed together by the collet holder.

2. The tool of claim 1, further comprising a set screw passing through the collet holder and into an axial slot cut into at least a portion of the collet, the set screw and axial slot permitting relative axial movement between the collet and the collet holder and preventing relative radial movement between the collet and the collet holder.

3. The tool of claim 1, further comprising:
a mounting bracket having a mounting bracket hole formed therein, the mounting bracket hole allowing a portion of the drive shaft to pass therethrough;
a support arm having a support arm hole formed therein, the support arm hole allowing a portion of the collet to pass therethrough.

4. The tool of claim 3, wherein the mounting bracket is fastened to the support arm.

5. The tool of claim 1, further comprising a pin resiliently pressing against a portion of the collet holder, the pin allowing the collet holder to rotate in a first direction and preventing the collet holder from continued rotation in a second direction.

6. The tool of claim 5, wherein the first direction is a counter-clockwise direction and the second direction is a clockwise direction.

7. The tool of claim 5, further comprising a spring resiliently pressing the pin into the collet holder.

8. The tool of claim 1, further comprising at least one magnet disposed in the mounting bracket.

9. A device for removing frangible collars from a bolt, the device comprising:
a collet holder;
a collet disposed inside a first end of the collet holder;
a flared end of the collet extending from the first end of the collet holder;
collet threads on at least a portion of an inside surface of the collet;
a drive shaft disposed inside a second, opposite end of the collet holder;
drive shaft threads adapted to mate with the collet threads;
a set screw passing through the collet holder and into an axial slot cut into at least a portion of the collet, the set screw and axial slot permitting relative axial movement between the collet and the collet holder and preventing relative radial movement between the collet and the collet holder;
a mounting bracket having a mounting bracket hole formed therein, the mounting bracket hole allowing a portion of the drive shaft to pass therethrough; and
a support arm having a support arm hole formed therein, the support arm hole allowing a portion of the collet to pass therethrough, wherein
rotation of the drive shaft causes the collet to be further inserted into the collet holder, causing the flared end of the collet to be compressed together by the collet holder.

10. The device of claim 9, further comprising a pin resiliently pressing against a portion of the collet holder, the pin allowing the collet holder to rotate in a first direction and preventing the collet holder from continued rotation in a second direction, wherein the first direction is a counter-clockwise direction and the second direction is a clockwise direction.
